(19) United States
(12) Patent Application Publication
(10) Pub. No.: US 2007/0234098 A1
(43) Pub. Date: Oct. 4, 2007

(54) Self-timed clock-controlled wait states

(76) Inventor: Ivo Tousek, Stockholm (SE)

Correspondence Address: BAKER & MCKENZIE LLP;PATENT DEPARTMENT, 2001 ROSS AVENUE, SUITE 2300, DALLAS, TX, 75201, US

(21) Appl. No.: 11/616,371

(22) Filed: Dec. 27, 2006

Related U.S. Application Data
(60) Provisional application No. 60/754,254, filed on Dec. 27, 2005.

(51) Int. Cl. G06F 1/00

(52) U.S. Cl. 713/500

(57) ABSTRACT

A peripheral device in a processor system which can generate system level wait states to temporarily stop the clock of a processor is disclosed. The system comprises at least one peripheral device, a wait-unknowledgeable processor, and a clock controller. The peripheral device generates a wait signal when the peripheral device is not ready to service a request, and the clock controller selectively turns off the clock signal to the processor. In this way, the processor can be waited by the peripheral for an arbitrary number of clock cycles until the processor request is serviced by the peripheral, even though the processor does not provide a dedicated wait input signal.

### RELATED APPLICATION

This application claims the benefit of the U.S. provisional application No. 60/754,254 filed on Dec. 27, 2005 entitled “Computer System with Clock-Controlled Wait States.”

### FIELD OF THE INVENTION

This invention relates to data transfers in computer systems, and more particularly to a peripheral device in a microprocessor system that can insert wait states to the processor when the processor does not provide a dedicated input signal to temporarily wait the processor's access to the peripheral.

### DESCRIPTION OF THE RELATED ART

Simple processors (microprocessors or digital signal processors) sometimes do not provide an external wait signal in their input interface. Such a wait signal is typically used (asserted) by peripheral devices that are operating slower than the processor itself, i.e., when the peripheral device needs to wait the processor's access to the peripheral.

When such a wait-unknowledgeable processor is communicating with a peripheral device, the peripheral device cannot simply assert a wait signal back to the processor in order to temporarily wait the processor's execution. Instead, techniques like polling or interrupt handling may be used.

When the wait-unknowledgeable processor issues a request to a slower peripheral device, the peripheral device can either assert an interrupt request to the processor as an indication that it is done with the processing of the request issued by the processor, or the processor can poll the peripheral device for status. As an example, if the processor issues a read data request to a slower peripheral device, then either an interrupt signal sent back to the processor or a status flag inside the peripheral device can be used as an indication that the processor now can read the requested data. Similarly, if the processor issues a write data request to a slower peripheral device, then either an interrupt signal sent back to the processor or a status flag inside the peripheral device can be used as an indication that the write request has been processed and the processor now can issue another request to the peripheral.

Referring now to FIG. 1, a schematic diagram of a conventional processor system according to the prior art is illustrated. The processor system includes a digital signal processing (DSP) processor 102, a memory 104, a memory arbiter 106 and system peripheral devices 108. The DSP processor 102, memory arbiter 106 and system peripheral devices 108 are coupled to a system bus 110. The DSP processor 102 and system peripheral devices 108 can access the memory 104 through the memory arbiter 106, as shown in the Figure.

When the processor 102 performs an access to one of the system peripheral devices 108, the communication overhead using polling or interrupt handling can be significant if the peripheral device 108 cannot immediately respond to the processor's request and the peripheral device 108 is slower than the processor 102 but not by a large amount, for example, if the peripheral device 108 can complete the processor's request after 1, 2, or a very few cycles.

Also, the programming model is not as user friendly if the simplest communication between the processor 102 and system peripheral device 108 (e.g. configuration of a slow peripheral device 108, reading and writing a few data words from/to the peripheral device 108) always has to occur using some higher-level mechanism such as polling or interrupt management.

Therefore, there is a need for an improved processor system structure which can offer a flexible yet powerful platform by offering system level wait states in some other manners.

### SUMMARY OF THE INVENTION

The present invention provides a peripheral device in a processor system, such as a digital signal processing (DSP) system, with the capability of dynamically controlling the clock of the processor.

One aspect of the present invention provides a peripheral device of a processor system. The peripheral device comprises a bus interface unit and a wait generator. The wait generator generates a wait signal to a processor when the peripheral device is not ready to service a request.

Another aspect of the present invention provides a processor system which comprises a peripheral device, a processor, and a clock controller. The peripheral device generates a wait signal when the peripheral device is not ready to service a request. The clock controller selectively turns on/off a clock signal to the processor.

Yet another aspect of the present invention provides a method for a peripheral device to respond to a request in a processor system. The method comprises the steps of 1) receiving a request from a processor of the processor system, 2) asserting a wait signal by the peripheral device to turn off a clock to the processor when the peripheral device can not service the request, and 3) de-asserting the wait signal to perform the data transfer between the processor and the peripheral when the request is ready to be serviced.

### BRIEF DESCRIPTION OF THE DRAWINGS

The accompanying drawings are included to provide a further understanding of the present invention, and are incorporated in and constitute a part of the description to this invention. The drawings illustrate embodiments of the present invention, and together with the description, serve to explain the principles of the present invention.

FIG. 1 illustrates a schematic diagram of a conventional processor system according to the prior art;

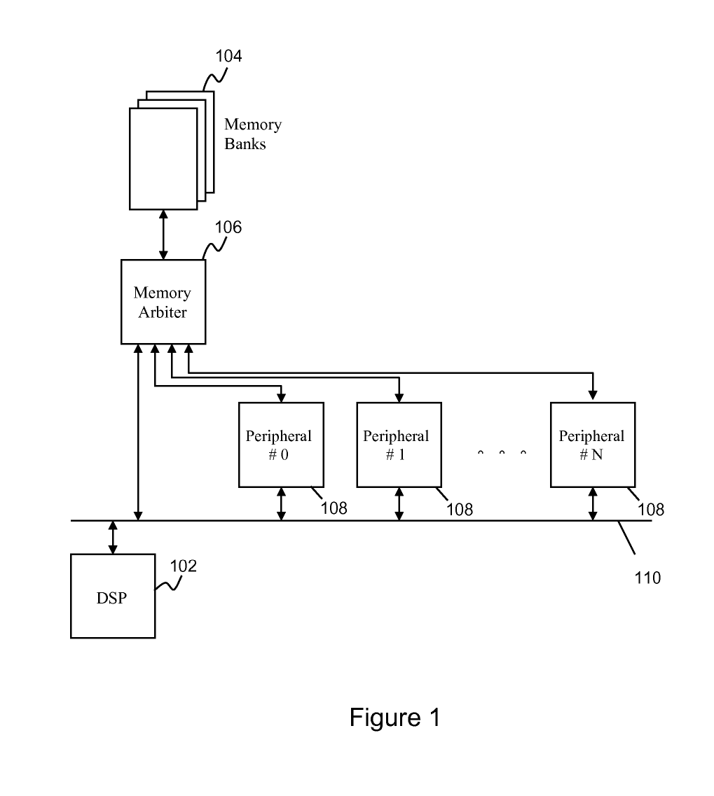

FIG. 2 illustrates a schematic diagram of a simple processor system according to a preferred embodiment of the present invention;

FIG. 3 illustrates a circuit diagram of an integrated clock gating cell according to a preferred embodiment of the present invention;

FIG. 4 illustrates a timing diagram showing two memory read requests issued consecutively by the DSP processor according to a preferred embodiment of the present invention;

FIG. 5 illustrates a timing diagram showing two memory write requests issued consecutively by the DSP processor according to a preferred embodiment of the present invention;

FIG. 6 illustrates a detailed block diagram representation of the preferred peripheral device according to the present invention; and

FIG. 7 illustrates a circuit diagram of a wait generator unit according to a preferred embodiment of the present invention.

FIG. 8 illustrates a flow chart of a preferred embodiment of the present invention.

### DESCRIPTION OF THE PREFERRED EMBODIMENTS

The invention disclosed herein is directed to a peripheral device in a processor system which inserts wait states to a wait-unknowledgeable processor by dynamically and temporarily stopping the clock to the processor. In the following description, numerous details are set forth in order to provide a thorough understanding of the present invention. It will be appreciated by one skilled in the art that variations of these specific details are possible while still achieving the results of the present invention. In other instances, well-known backgrounds are not described in detail in order not to unnecessarily obscure the present invention.

One aspect of the present invention is to enable a peripheral device to generate a wait signal when the peripheral device is not ready to service a request from the processor. The wait signal triggers the clock controller to selectively turn off a clock signal to the processor when the peripheral device cannot service a request. This way, the processor, which does not provide a dedicated wait input signal, can still be waited by the peripheral device for an arbitrary number of clock cycles until the processor request is serviced by the peripheral device.

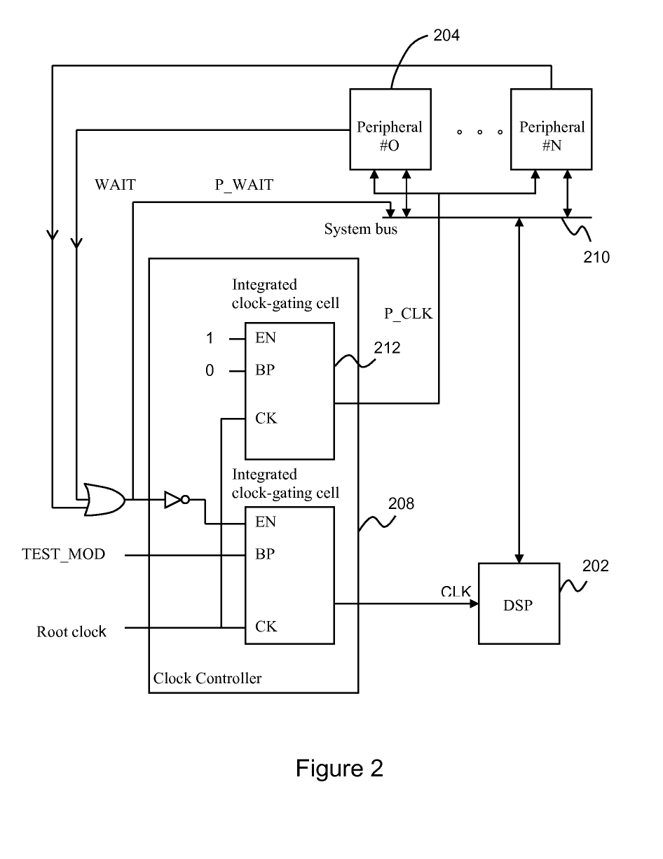

Referring now to FIG. 2, a schematic diagram of a simple processor system according to a preferred embodiment of the present invention is illustrated. The processor system includes a processor 202, a plurality of peripheral devices 204, a memory arbiter (not shown in the Figure) and a clock control unit 208. The processor 202 and peripheral devices 204 are connected to a system bus 210. The processor 202 and peripheral devices 204 can access the memory through the memory arbiter (not shown in the Figure). All the wait signals WAITs driven by the peripheral devices 204 are performed with OR operation to produce a P_WAIT signal, which is then driven back to all peripheral devices as part of the system bus 210 and transmitted to the clock controller 208. The clock controller 208 provides two clocks, P_CLK and CLK, to the peripheral devices 204 and the processor 202, respectively. The peripheral devices 204 cannot wait the processor 202 by simply driving an active wait signal to one of the processor's input. Instead, the peripheral devices 204 drive their respective wait signals to the clock controller 208 which will temporarily turn-off the clock signal CLK sent to the processor 202 when P_WAIT is asserted. In one embodiment, the processor 202 is a DSP processor and the clock controller 208 comprises two clock-gating cells 212 to output two clocks, P_CLK and CLK to the peripheral devices 204 and the DSP processor 202, respectively.

The wait signal WAIT is controlled dynamically and individually in each peripheral device 204. Peripheral devices 204 in the system may have different response times to a processor request, and the response time from a single peripheral device 204 may even differ from time to time for the same type of processor request due to the dynamics of the processor system.

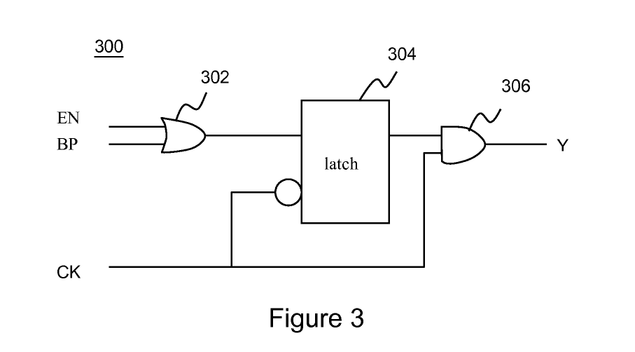

Referring now to FIG. 3, a circuit diagram of an integrated clock gating cell according to a preferred embodiment is illustrated. The clock gating cell 300, which may be used as clock-gating cells 212 shown in the FIG. 2, comprises 1) an OR gate 302, 2) a latch 304, and 3) an AND gate 306. The clock gating cell 300 can be triggered by the inputs of an enable signal EN. It can be driven by the inverse of the P_WAIT signal in the example of FIG. 2, or by a test mode signal BP to provide a clock output CLK. In one embodiment, the clock gating element indicated is used for clock gating of positive edge triggered flip-flops. Other clock gating elements may be used for negative edge triggered flip-flops.

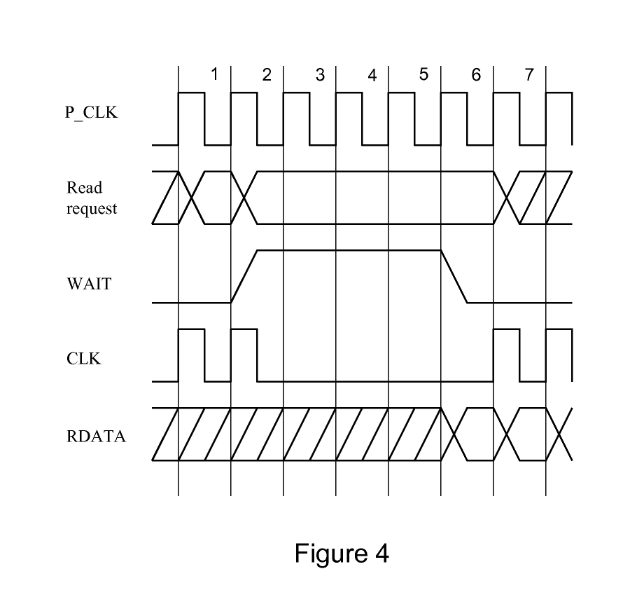

Referring now to FIG. 4, a timing diagram showing two memory read requests issued consecutively by a processor according to a preferred embodiment is illustrated. In the example, the P_CLK is the clock to one of the peripheral devices 204, and CLK is the clock to the processor 202. The processor 202 issues a read request in cycle 1 which is waited by the peripheral device 204 during cycles 2-5 by asserting a WAIT signal. The peripheral device 204 asserts the WAIT signal resulting the P_WAIT signal to be enabled, which then disables the CLK clock from the clock controller 208. When the requested data is available in the peripheral device 204, it de-asserts the WAIT signal and drives the read data to the RDATA bus to the processor 202 which captures the data on the next clock edge. The diagram illustrates that the next read request, issued by the processor 202 in cycle 2, is stalled behind the first read request until the first read request is serviced in cycle 6 and the associated read data is present on the RDATA bus in cycle 7. In this example, the second read request is serviced immediately by the peripheral device without being waited. The waited read request from cycle 1 is buffered internally in the accessed peripheral device 204 until it is serviced, as it is taken off the system bus 210 in the next cycle.

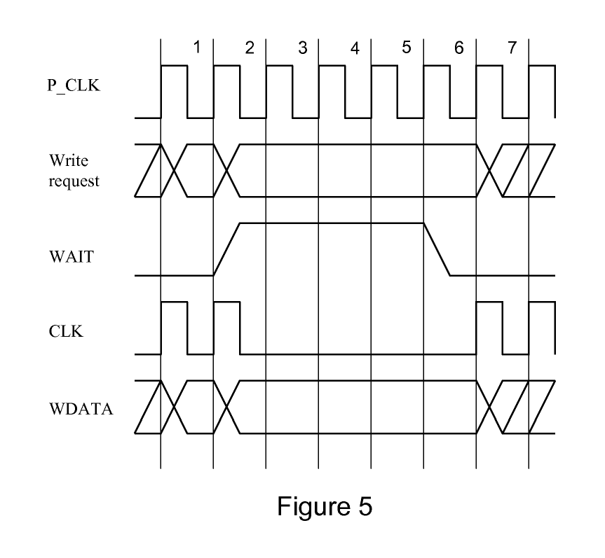

Referring now to FIG. 5, a timing diagram showing two write requests issued consecutively by the DSP processor to one of the peripheral devices 204 according to a preferred embodiment is illustrated. In the example, the processor 202 issues a write request in cycle 1 which is waited by the peripheral device 204 during cycles 2-5, and the second write request is performed in cycle 6 without being waited by the peripheral device 204. Similarly, the first write request and the associated write data present on the WDATA bus has to be buffered internally in the accessed peripheral device 204 until it is serviced, as it is taken off the system bus 210 in the next cycle.

A benefit of the present invention is that the wait-unknowledgeable DSP processor can issue a single access request or sequences of access requests to its peripheral devices without using higher level polling or interrupt handling. When requests issued by a processor result in a few wait states being inserted by a slow peripheral device, better performance can be achieved. Overall code density is also improved and processor programming is simplified.

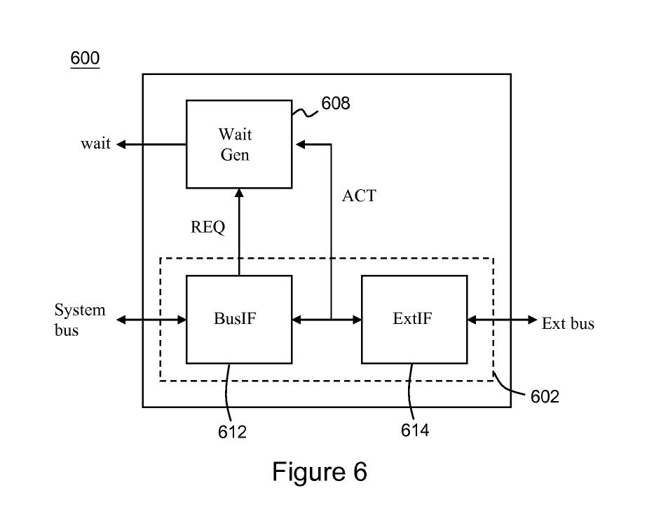

Referring now to FIG. 6, a detailed block diagram representation of the preferred peripheral device according to the present invention is shown. In one embodiment, the peripheral device 600 comprises a bus interface unit 602 and a wait generator 608. The bus interface unit 602 may further comprise two bus interfaces, system bus interface unit BusIF 612 and external bus interface unit ExtIF 614, that interface a system bus and an external bus, respectively. The wait generator 608 generates a WAIT signal to the DSP processor when the peripheral device 600 is not ready to service the DSP processor. The peripheral device 600 may provide data processing tasks which may take a number of clock cycles to process. In such case, when accessed by the DSP processor over the system bus, the peripheral device 600 may assert its WAIT signal until it completes its multi-cycle processing and is ready to service the DSP processor. In response to a request made by the processor, the peripheral device 600 may access other devices connected to the external bus through the ExtIf interface 614. Peripheral devices 600 that do not communicate with such other devices need not implement the ExtIF 614 interface.

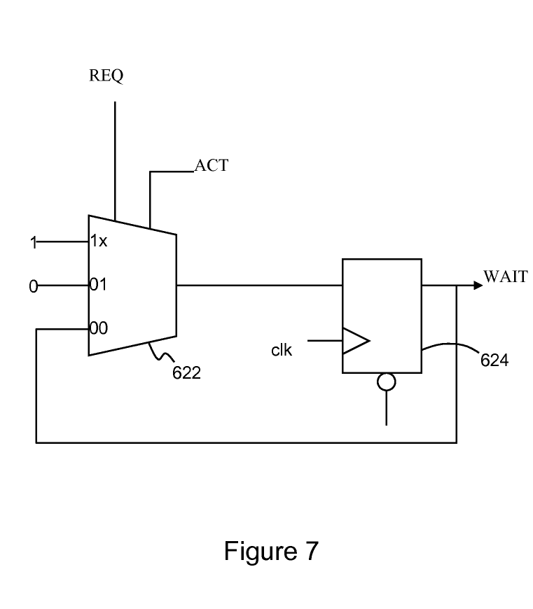

The system bus interface unit BusIF 612 decodes the processor's requests/commands from the system bus and generates control signals to the wait generator 608. When the system bus interface unit BusIF 612 detects an active read request over the system bus, it asserts the request signal REQ in cycles 1 and 6 in FIG. 4. Similarly, when the system bus interface unit Busif 612 detects an active write request over the system bus, it asserts the request signal REQ in cycles 1 and 6 in FIG. 5. The system bus access to the peripheral device 600 can target internal logic within the peripheral, or external logic which is then accessed by the peripheral device 600 over the external bus. An access can be either a single-cycle access or a multi-cycle access. The active signal ACT is asserted when the request is performed in cycles 5 and 6 in FIGS. 4 and 5. If the access targets an address internally in the peripheral device 600, then ACT may be turned active by the peripheral device's internal core logic. If the access targets an address on the external bus, then ACT may be turned active by ExtIF interface 614. All accesses over the system bus are considered invalid while the global P_WAIT is asserted. The wait generator 608 drives the WAIT signal to the clock controller. One example of the wait generator unit 608 is shown in FIG. 7. The wait generator 608 controls the flip-flop 624 to output a WAIT signal upon the selection of the multiplexer 622, which is based on the states of REQ and ACT signals.

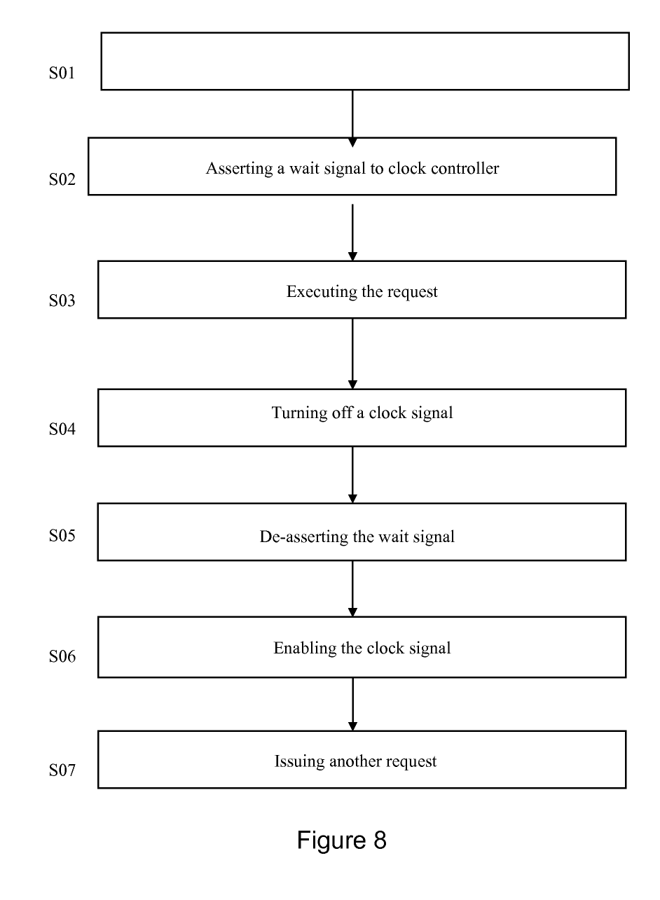

Referring now to FIG. 8 which illustrates a flow chart of a preferred embodiment of the present invention. First in step S01, the processor issues a request to a peripheral device. The request may be a data read request, a data write request or any other kind of requests. In step S02, the peripheral devices asserts a wait signal to a clock controller in response to the request because the peripheral device has slower processing rate. In step S03, the clock controller turns off a clock signal to the processor in response to the assertion of the wait signal. Once the clock signal is turned off, any incoming request from the processor will be halted for execution. In step S04 the peripheral device executes internal access or operation required by the first request, while the processor is put in wait for the completion of the request. After the peripheral device completes the execution of the request, the peripheral device de-asserts the wait signal in step S05. In step S06, the clock signal is enabled. In the next step S07, the processor is able to issue another request to the peripheral device.

Although the present invention has been described in considerable detail with references to certain preferred versions thereof, other variations are possible and contemplated. For example, the clock gating cell can be in other embodiment such as clock trees. More over, although the present disclosure contemplates one implementation using the peripheral devices in a DSP system, it may also be applied in a similar manner in other computer system and the like.

Finally, those skilled in the art would appreciate that they can readily use the disclosed conception and specific embodiments as a basis for designing or modifying other structures for carrying out the same purpose of the present invention without departing from the spirit and scope of the present invention as defined by the appended claims.

What is claimed is:

1. A peripheral device in a computer system, comprising:
a bus interface unit configured to receive a request from a processor and to generate a control signal in response to said request; and
a wait generator for generating a wait signal to a clock controller coupled to said processor according to said control signal, wherein said clock controller provides a clock signal to said processor.

2. The peripheral device according to claim 1, wherein said bus interface unit comprises a system bus interface and an external bus interface, wherein said request is received from a system bus of said computer system via said system bus interface.

3. The peripheral device according to claim 1, wherein said control signal is chosen from the following:
an active request signal which is enabled in response to said request;
an active signal which is enabled in response to the execution of said request.

4. The peripheral device according to claim 1, wherein said wait signal is asserted in response to said enabled control signal.

5. The peripheral device according to claim 4, wherein said clock controller disables said clock signal sent to said processor in response to said asserted wait signal.

6. A processor system without wait-knowledgeable function, comprising:
a processor to issue a request;
at least one peripheral device to generate a wait signal in response to said request from said processor; and
a clock controller to selectively turn-off a clock signal to said processor according to said wait signal.

7. The processor system according to claim 6, wherein said request issued by said processor cannot be waited by a dedicated wait input signal pin of said processor.

8. The processor system according to claim 6, wherein said peripheral device comprising:
a bus interface unit configured to receive said request from said processor and to generate a control signal in response to said request; and
a wait generator that generates said wait signal to said clock controller according to said control signal.

9. The processor system according to claim 8, wherein said bus interface unit comprises of a system bus interface and an external bus interface wherein said request is received from a system bus of said processor system via said system bus interface.

10. The processor system according to claim 8, wherein said wait signal is asserted in response to said enabled control signal.

11. The processor system according to claim 8, wherein said control signal is chosen from the following:
an active request signal which is enabled in response to said request;
an active signal which is enabled in response to the execution of said request.

12. The processor system according to claim 6, wherein said clock controller drives one clock signal to said processor and another clock signal to said peripheral device.

13. The processor system according to claim 12, wherein said clock controller turns off said clock signal sent to said processor in response to said asserted wait signal.

14. The processor system according to claim 12, wherein said processor is halted from issuing another request when said wait signal is asserted.

15. A method for a peripheral device to respond to a request in a processor system, comprising:
receiving said request from a processor of said processor system;
asserting a wait signal by said peripheral device to turn off a clock signal to said processor of said processor system in response to said request;
de-asserting said wait signal to perform a data transfer requested by said processor according to said request.

16. The method according to claim 15, wherein said request received from said processor cannot be waited by a dedicated wait input signal pin of said processor.

17. The method according to claim 15, wherein said de-asserting step further comprises turning on said clock signal to said processor.

18. The method according to claim 15, wherein said wait signal is triggered by a bus interface unit of said peripheral device indicating that said request is still processing inside said peripheral device.

19. The method according to claim 15, wherein said processor of the processing system is halted from issuing another request during the asserting step.
